(19) United States
(12) Patent Application Publication
(10) Pub. No.: US 2015/0189501 A1
(43) Pub. Date: Jul. 2, 2015

(54) COMMUNICATION DEVICE AND CONTACT LIST DISPLAYING METHOD

(71) Applicants: Fu Tai Hua Industry (Shenzhen) Co., Ltd., Shenzhen (CN); HON HAI PRECISION INDUSTRY CO., LTD., New Taipei (TW)

(72) Inventor: Yu TAN, Shenzhen (CN)

(21) Appl. No.: 14/543,130

(22) Filed: Nov. 17, 2014

(30) Foreign Application Priority Data
Dec. 30, 2013 (CN) 201310744290.6

(51) Int. Cl. H04W 8/24; H04L 29/12; H04M 1/725

(52) U.S. Cl. CPC H04W 8/245; H04M 1/72563; H04L 61/1594

(57) ABSTRACT

A communication device stores a contact list including a number of telephone numbers. The communication device communicates with a base station, and the base station can communicate with many communication devices and can obtain a working mode of a telephone number of the communication devices. The communication device obtains the telephone numbers recorded in the contact list and obtains the working mode of the obtained telephone numbers from the base station. The communication device further displays each of the obtained working modes in a position corresponding to the corresponding telephone number.

### CROSS-REFERENCE TO RELATED APPLICATIONS

This application claims priority to Chinese Patent Application No. 201310744290.6 filed on Dec. 30, 2013, the contents of which are incorporated by reference herein.

### FIELD

The subject matter herein generally relates to communication devices, and particularly to a communication device and a contact list displaying method thereof.

### BACKGROUND

A user may want to use a mobile phone to communicate with a contact person recorded in a contact list, however the user may not know whether the contact person is conveniently able to answer the communication.

### BRIEF DESCRIPTION OF THE DRAWINGS

Implementations of the present technology will now be described, by way of example only, with reference to the attached figures.

FIG. 1 is a block diagram illustrating an example embodiment of a communication device.

FIG. 2 is a diagrammatic illustration of example embodiments showing a contact list interface displayed in the communication device of FIG. 1.

FIG. 3 is a flow chart illustrating an example embodiment of a contact list displaying method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein, However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein.

Several definitions that apply throughout disclosure will now be presented. The term “module” refers to logic embodied in computing or firmware, or to a collection of software instruction, written in a programming language, such as Java, C, or assembly. One or more software instruction in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “coupled” is defined as connected, whether directly or indirectly through intervening components, and is not necessarily limited to physical connections. The connection can be such that the objects are permanently connected or releasably connected. The term “comprising” means “including, but not necessarily limited to”, it specifically indicates open-ended inclusion or membership in a so-described combination, group, series and the like.

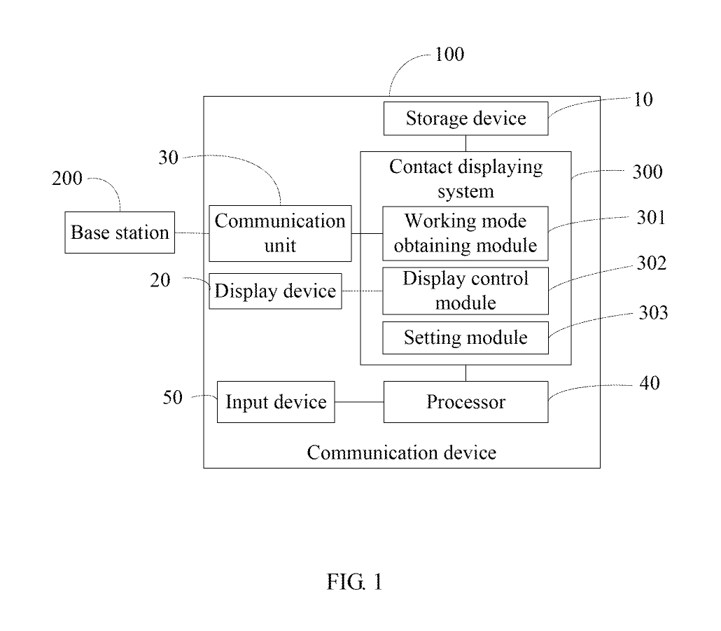

FIG. 1 illustrates a block diagram of a communication device 100. The communication device 100 can be a mobile phone and the like. The communication device 100 can communicate with a base station 200. The base station 200 also can communicate with many other communication devices (not shown). The base station 200 can obtain working modes of the telephone number used by each of the communication devices communicated with the base station 200. In this embodiment, the working modes can include an out of service mode, an idle mode, a busy mode, a no disturbing mode, and the like. The out of service mode can indicate that the communication device 100 using the telephone number is disconnected from the base station 200, and the telephone number cannot be normally used. The idle mode can indicate that the telephone number of the communication device 100 is idle, and the communication device 100 using the telephone number can establish communications with other communication devices. The busy mode can indicate that the telephone number is busy, namely the communication device 100 using the telephone number communicates with another communication device now and cannot establish communications with other communication devices. The no disturbing mode can indicate that the user of the telephone number does not want to be disturbed by others. In this embodiment, the telephone number can be set to the no disturbing mode by the user via the communication device 100 using the telephone number.

In at least one embodiment, the communication device 100 can include a storage device 10, a display device 20, a communication unit 30, a processor 40, and an input device 50. In at least one embodiment, the processor 40 can be a central processing unit, a digital signal processor, or a single chip, for example. The storage device 10 is coupled to the processor 40. The storage device 10 can be an internal storage system, such as a flash memory, a random access memory (RAM) for temporary storage of information, and/or a read-only memory (ROM) for permanent storage of information. The storage device 10 can also be a storage system, such as a hard disk, a storage card, or a data storage medium. The storage device 10 can include volatile and/or non-volatile storage devices. In at least one embodiment, the storage device 10 can include two or more storage devices such that one storage device is a memory and the other storage device is a hard drive. Additionally, one or more of the storage devices 10 can be located either entirely or partially external relative to the communication device 100.

The storage device 100 can store a contact list. The contact list can include a number of names of contact persons and a number of telephone numbers, the name of each contact person corresponds to at least one of the telephone numbers. The display device 20 is configured to display the contact list. The communication unit 30 is configured to communicate the communication device with the base station 200. The display device 20 can be a display panel, a touch screen, or the like. The communication unit 30 can be the 3rd generation telecommunication card, a WIFI chip, a phone card, or the like.

In this embodiment, a contact list displaying system 300 can be stored in the storage device 10. The contact list displaying system 300 can include a number of modules, which are collection of software instructions stored in the storage device 10 and executed by the processor 40. In at least one embodiment, the contact list displaying system 300 can include a working mode obtaining module 301, a display control module 302, and a setting module 303.

The working mode obtaining module 301 is configured to obtain the telephone numbers from the contact list, and obtain the working mode of each of the obtained telephone number from the base station 200 via the communication unit 30. In this embodiment, the working mode obtaining module 301 obtains all the telephone numbers recorded in the contact list and the working modes of all the telephone numbers. In other embodiments, the working mode obtaining module 301 obtains the telephone numbers selected by the user, and the working modes of the selected telephone numbers.

In this embodiment, the working mode obtaining module 301 obtains the telephone numbers from the contact list in response to user inputs for obtaining the telephone numbers via the input device 50. In an alternative embodiment, the working mode obtaining module 301 automatically obtains the telephone numbers and the working mode of each of the telephone numbers once the communication device 100 is starting up. In other embodiments, the working mode obtaining module 301 obtains the telephone numbers and the working mode of each of the telephone numbers at intervals (such as every 1 hour).

In this embodiment, the working mode obtaining module 301 obtains the working mode of the telephone numbers as follows: the working mode obtaining module 301 generates a querying signal for querying the working mode of each of the obtained telephone number. The querying signal can include all of the obtained telephone numbers. The working mode obtaining module 301 sends the querying signal to the base station 200 via the communication unit 30. When the base station 200 receives the querying signal sent by the communication device 100, the base station 200 obtains the current working mode of each telephone number included in the querying signal. The base station 200 further generates a response signal including the obtained telephone numbers and corresponding working mode of each of the telephone numbers, and sends the response signal to the communication device 100. The working mode obtaining 201 obtains the response signal from the base station 200 via the communication unit 30.

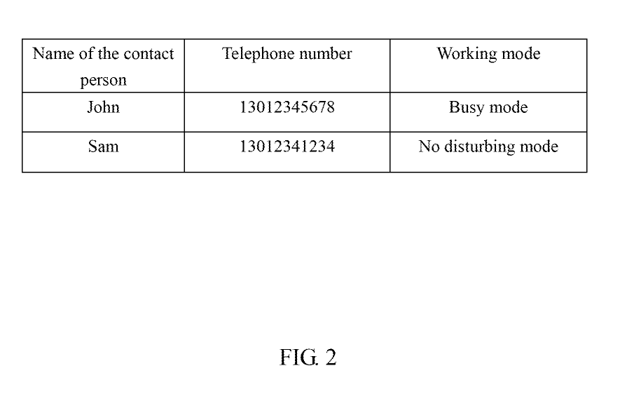

The display control module 302 is configured to control the display device 20 to display the obtained working mode of each telephone number on a position of the contact list corresponding to a position of the corresponding telephone number in the contact list. Namely, the display control module 302 displays the obtained working modes on the contact list and the position of the working mode of each telephone number is corresponded to the telephone number in the contact list. For example, as shown in FIG. 2, in the contact list, the telephone number 13012345678 corresponds to a busy mode, the telephone number 13012345678 and the busy mode are displayed on the contact list together, the telephone number 13012341234 corresponds to a no disturbing mode, and the telephone number 13012341234 and the no disturbing mode are displayed on the contact list together.

The setting module 303 is configured to set the working mode of the telephone number of the communicate device 100, in response to a setting operation on the input device 50. For example, if the user of the communication device 100 does not want to be disturbed by phone calls and messages, the user can set the working mode of his/her telephone number as the no disturbing mode via the input device 50. If the user is idle, the user can set the working mode of his/her telephone number as the idle mode via the input device 50. It can be understood that the busy mode and the out of service can be automatically set when the communication device 100 is on the phone or is out of service.

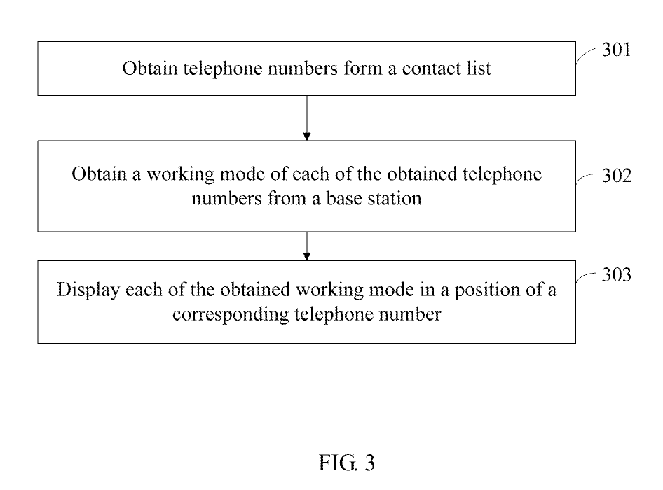

FIG. 3 illustrates an embodiment of a contact list displaying method applied in a communication device. The method is provided by way of example, as there are a variety of ways to carry out the method. The method described below can be carried out using the configurations illustrated in FIG. 1, for example, and various elements of these figures are referenced in explaining the example method. Each block shown in FIG. 3 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 301.

At block 301, a working mode obtaining module obtains telephone numbers from a contact list stored in an storage device.

At block 302, the working mode obtaining module obtains a working mode of each of the obtained telephone numbers from a base station.

At block 303, a display control module displays each of the obtained working modes on a position of the contact list corresponding to a position of the corresponding telephone number in a contact list displayed on the display device 20.

In this embodiment, the method further can include: a setting module sets the working mode of the telephone number of the communicate electronic device in response to a setting operation on the input device.

The embodiments shown and described above are only examples. Many further details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A communication device comprising:
a communication unit configured to communicate with a base station, the base station capable of communicating with a plurality of communication devices and obtaining a working mode of telephone numbers of the plurality of communication devices that communicate with the base station;
a storage device configured to store a contact list, the contact list comprising a number of telephone numbers;
a processor coupled to the storage device;
a display device coupled to the processor; and
a working mode obtaining module, stored in the storage device, comprising at least one instruction configured to cause the processor to obtain at least one telephone number from the contact list, and obtain the working mode of the at least one telephone number from the base station via the communication unit.

2. The communication device of claim 1, further comprising a display control module, stored in the storage device, comprising at least one instruction configured to cause the processor to control the display device to display the working mode obtained by the processor on a position corresponding to a position of a corresponding telephone number in the contact list.

3. The communication device of claim 1, wherein the working mode comprises an out of service mode, an idle mode, a busy mode, and a no disturbing mode; the out of service mode indicates that the communication device using the telephone number is disconnected from the base station and the telephone number cannot be normally used; the idle mode indicates that the telephone number of the communication device is idle, and the communication device using the telephone number can establish communications with other communication devices; the busy mode indicates that the telephone number is busy and the communication device cannot establish communications with other communication devices; and the no disturbing mode is set by the user to indicate that the user of the telephone number does not want to be disturbed by others.

4. The communication device of claim 1, further comprising an input device to receive user input, wherein the working mode obtaining module further causes the processor to obtain the telephone numbers and the working modes in response to user inputs for querying the working mode.

5. The communication device of claim 1, wherein the working mode causes the processor to automatically obtains the telephone numbers and the working modes of each of the telephone numbers once the communication device is starting up or obtains the telephone numbers and the working modes at regular intervals.

6. The communication device of claim 1, wherein the working mode obtaining module causes the processor to obtains the telephone numbers selected by a user, and obtains the working mode of the telephone numbers selected by the user.

7. The communication device of claim 1, wherein the working mode obtaining module cause the processor to obtain the working mode of the telephone numbers as follows: the working mode obtaining module cause the processor to generates a querying signal comprising the telephone numbers obtained by the processor for querying the working mode of the telephone numbers, and send the querying signal to the base station when the base station receives the querying signal, the base station obtains a current working mode of each telephone number comprised in the querying signal; the base station further generates a response signal comprising the telephones numbers and corresponding working mode of each telephone number, and sends the response signal to the communication device; the processor of the communication device obtains the working modes of the telephone numbers from the response signal received by the communication device.

8. The communication device of claim 1, wherein the communication device further comprises an input device and a setting module, the setting module is stored in the storage device and comprises instructions configured to cause the processor to set the working mode of the telephone number of the communication device in response to a setting operation inputted by a user on the input device.

9. A contact list displaying method applied in a communication device, the communication device comprises a processor and a storage device storing a contact list comprising a plurality of telephone numbers, the communication device capable of communicating with a base station, the base station capable of communicating with a plurality of communication devices and obtaining a working mode of telephone numbers of the communication devices communicate with the base station; the method comprising:
obtaining at least one telephone numbers from the contact list by the processor; and
obtaining the working mode of the at least one telephone numbers obtained from the contact list from the base station by the processor.

10. The contact list displaying method of claim 9, further comprising:
displaying the working mode obtained from the base station in a position of a corresponding telephone number in the contact list by the processor.

11. The contact list displaying method of claim 9, wherein the working mode comprises an out of service mode, an idle mode, a busy mode, and a no disturbing mode; the out of service mode indicates that the communication device using the telephone number is disconnected from the base station and the telephone number cannot be normally used; the idle mode indicates that the telephone number of the communication device is idle, and the communication device using the telephone number can establish communications with other communication devices; the busy mode indicates that the telephone number is busy, and the communication device cannot establish communications with other communication devices; and the no disturbing mode is set by the user to indicate that the user of the telephone number does not want to be disturbed by others.

12. The contact list displaying method of claim 9, wherein the telephone numbers and the working modes are obtained in response to user inputs for querying the working mode.

13. The contact list displaying method of claim 9, wherein the telephone numbers and the working modes of each of the telephone numbers are automatically obtained once the communication device is starting up or the telephone numbers and the working modes are automatically obtained at regular intervals.

14. The contact list displaying method of claim 9, wherein the obtained telephones are selected by a user.

15. The contact list displaying method of claim 9, wherein “obtaining the working mode of each of the telephone numbers from the base station” comprises:
generating a querying signal for querying the working mode of the telephone numbers by the processor, the querying signal comprising the telephone numbers obtained by the processor;
sending the querying signal to the base station, when the base station receives the querying signal, the querying signal causes the base station to obtain the working mode of each telephone number comprised in the querying signal, and generate a response signal comprising the telephones numbers and corresponding working mode of each telephone number; and
obtaining the response signal from the base station, and obtaining the working modes of the telephone numbers from the response signal.

16. The contact list displaying method of claim 9, further comprising:
setting the working mode of the telephone number of the communicate electronic device in response to a setting operation inputted by a user.
